(19) United States
(12) Patent Application Publication
(10) Pub. No.: US 2014/0070659 A1
(43) Pub. Date: Mar. 13, 2014

(54) STATOR ASSEMBLY FOR MOTOR

(71) Applicant: SAMSUNG ELECTRO-MECHANICS CO., LTD., Gyunggi-do (KR)

(72) Inventors: Ki Young Lee, Gyunggi-do (KR); Jung Kyu Yim, Gyunggi-do (KR); Moon Kyu Han, Gyunggi-do (KR)

(73) Assignee: SAMSUNG ELECTRO-MECHANICS CO., LTD., Gyunggi-do (KR)

(21) Appl. No.: 13/677,025

(22) Filed: Nov. 14, 2012

(30) Foreign Application Priority Data
Sep. 7, 2012 (KR) 10-2012-0099136

(51) Int. Cl. H02K 1/18

(52) U.S. Cl. CPC H02K 1/185
USPC 310/216.104

(57) ABSTRACT

Disclosed herein is a stator assembly for a motor including: a core member provided with a ring shaped yoke part and a plurality of coil winding parts spaced apart from each other at equidistance in a circumferential direction to be extended from the yoke part; and a tip member alternately provided with at least one mounting part having hollow parts and made of a magnetic material and at least one connecting part disposed between the mounting parts, wherein each of the end portions of the coil winding parts is fixedly positioned at each of the hollow parts.

### CROSS REFERENCE TO RELATED APPLICATION

This application claims the benefit of Korean Patent Application No. 10-2012-0099136, filed on Sep. 7, 2012, entitled “Stator Assembly for a Motor”, which is hereby incorporated by reference in its entirety into this application.

### BACKGROUND OF THE INVENTION

1. Technical Field

The present invention relates to a stator assembly for a motor.

2. Description of the Related Art

A motor, which is a device converting electric energy into mechanical energy to provide rotational force, is generally configured of a stator including a coil wound therearound and a rotor including a magnet. The rotor is rotatably received in the stator. That is, the motor is rotated by repulsive force and attractive force generated according to a polarity of the rotor and a polarity of the stator.

In the motor having this structure, in order to implement miniaturization and thinness and reduce manufacturing cost, the stator capable of implementing various shapes by manufacturing a front end portion of the stator arranged to face a rotor, having a predetermined gap therebetween using a soft magnetic composite has been developed.

The stator used for this motor is disclosed in Patent Document 1.

The stator of the motor disclosed in Patent Document 1 is formed by laminating a plurality of steel plates as widely known and configured of a yoke part, a plurality of coil winding parts extended toward the center from the yoke part, and front end portions made of a soft magnetic composite to be disposed at distal ends of the coil winding part.

In addition, the stator disclosed in Patent Document 1 includes a connecting part at the distal end of the coil winding part so as to prevent the front end portion from being separated from the distal end of the coil winding part.

In the stator as described above, the front end portion made of the soft magnetic composite is mounted on each of the distal ends of the coil winding parts disposed by a predetermined interval from the yoke part.

The stator according to the prior art has a structure in which general laminated steel plates should be used and the front end portion should be inserted into and fixed to each of the distal ends of the coil winding part one by one at the time of assembling.

Therefore, other solutions capable of solving the above-mentioned problems should be considered.

### PRIOR ART DOCUMENT

### Patent Document

(Patent Document 1) Korean Patent Laid-Open Publication No. 10-2007-0092816

### SUMMARY OF THE INVENTION

The present invention has been made in an effort to provide a stator assembly for a motor designed so as to minimize eddy current loss and have high efficiency using a magnetic material, especially a soft magnetic composite capable of being formed in various 3-dimensional shapes.

According to a preferred embodiment of the present invention, there is provided a stator assembly for a motor including: a core member provided with a ring shaped yoke part and a plurality of coil winding parts spaced apart from each other at equidistance in a circumferential direction to be extended from the yoke part; and a band shaped tip member alternately provided with at least one mounting part having a hollow part and at least one connecting part disposed between the mounting parts.

The mounting part may be made of a magnetic material, for example soft magnetic composite (SMC).

The hollow part of the mounting part may have the same cross-sectional shape as that of an end portion of the coil winding part, and the end portion of the coil winding part may be easily inserted into the hollow part of the mounting part to fix the tip member.

The tip member may have a band shape in which the mounting part and the connecting part are alternately arranged, and the band shaped tip member may have a length equal to a circumference of a virtual circle formed of end portions of the plurality of coil winding parts to assist the tip member in being certainly seat on the end portion of the coil winding part. As needed, the band shaped tip member may have a length longer than the circumference of the virtual circle.

The tip member may have a ring shape in which connecting parts of both of the end portions thereof are formed integrally with each other rather than the band shape and be certainly fitted to the end portions of the plurality of coil winding parts arranged in a spoke shape. To this end, the connecting part may be extended at the same length as a spaced distance between the end portions of the plurality of coil winding parts.

The connecting part may be made of a non-magnetic material.

The number of mounting parts of the tip member may be the same as that of coil winding part, such that the mounting parts may be arranged at each of the coil winding parts.

According to another preferred embodiment of the present invention, there is provided a stator assembly for a motor including: a core member provided with a ring shaped yoke part and a plurality of coil winding parts spaced apart from each other at equidistance in a circumferential direction to be extended from the yoke part; and a ring shaped tip member configured of a first tip half part including at least one fitting part and at least one connecting part that are alternately arranged in a ring shape and a second tip half part including at least one fitting part and at least one connecting part that are alternately arranged in a ring shape, wherein the fitting parts of the first and second tip half parts are arranged to face each other to form hollow parts. The hollow parts may serve as space receiving end portions of the coil winding parts.

The fitting part may be made of a magnetic material, for example soft magnetic composite (SMC).

The fitting part of the first tip half part may have the same cross-sectional shape as that of an upper portion of the end portion of the coil winding part, and the fitting part of the second tip half part may have the same cross-sectional shape as that of a lower portion of the end portion thereof That is, the first tip half part may be arranged at an upper portion of the end portion of the coil winding part, and the second tip half part may be arranged at a lower portion of the end portion thereof, thereby forming hollow parts.

The ring shaped tip member may have the same length as a circumference of a virtual circle formed of end portions of the plurality of coil winding parts.

The connecting part may be made of a non-magnetic material.

The connecting part may be extended with the same length as a spaced distance between the end portions of the plurality of coil winding parts.

According to another preferred embodiment of the present invention, there is provided a stator assembly for a motor including: a core member provided with a ring shaped yoke part and a plurality of coil winding parts spaced apart from each other at equidistance in a circumferential direction to be extended from the yoke part; and a tip member configured of a first tip half part including at least one fitting part, at least one coil winding part upper cover, and a ring shaped yoke part upper cover and a second tip half part including at least one fitting part, at least one coil winding part lower cover, and a ring shaped yoke part lower cover, wherein the fitting parts of the first and second tip half parts are arranged to face each other to form hollow parts. The hollow parts may serve as space receiving end portions of the coil winding parts.

One end portions of the coil winding part upper and lower covers may be coupled to the ring shaped yoke part upper and lower covers, and the other end portions of the of the coil winding part upper and lower covers may be coupled to the fitting parts of the first and second tip half parts.

The numbers of the fitting part and the coil winding part cover may be the same as that of coil winding part.

The coil winding part upper cover may have the same shape as that of an upper portion of the coil winding part, and the coil winding part lower cover may have the same shape as that of a lower portion thereof In addition, the yoke part upper cover may have the same shape as that of an upper portion of the yoke part, and the yoke part lower cover may have the same shape as that of a lower portion thereof Therefore, the first and second tip half parts may be certainly seated in a vertical direction of the core member.

The fitting part may be made of a magnetic material, for example soft magnetic composite (SMC).

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a stator assembly for a motor according to a first preferred embodiment of the present invention;

FIG. 2 is an exploded perspective view of the stator assembly for a motor shown in FIG. 1;

FIG. 3 is an enlarged view of a tip member to be mounted on the stator assembly for a motor shown in FIG. 2;

FIG. 4 is a perspective view showing a stator assembly for a motor according to a second preferred embodiment of the present invention;

FIG. 5 is an exploded perspective view of the stator assembly for a motor shown in FIG. 4;

FIG. 6 is a detailed view of a tip member to be mounted on the stator assembly for a motor shown in FIG. 5; and

FIG. 7 is an enlarged view of another tip member to be mounted on a stator assembly for a motor according to a third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

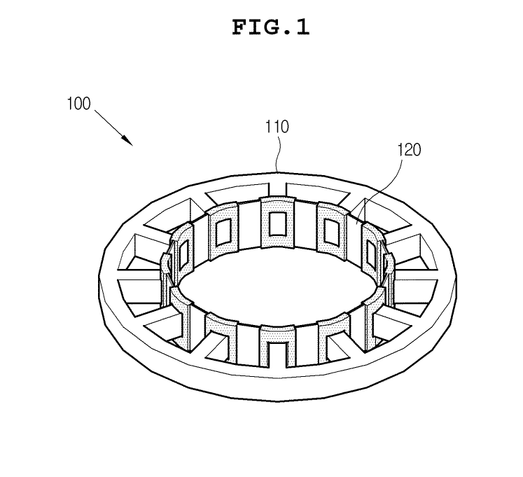

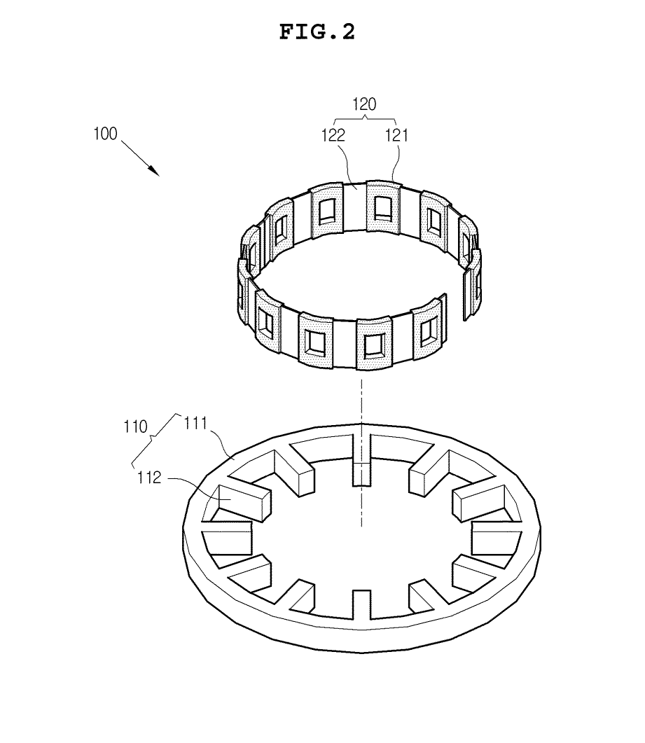

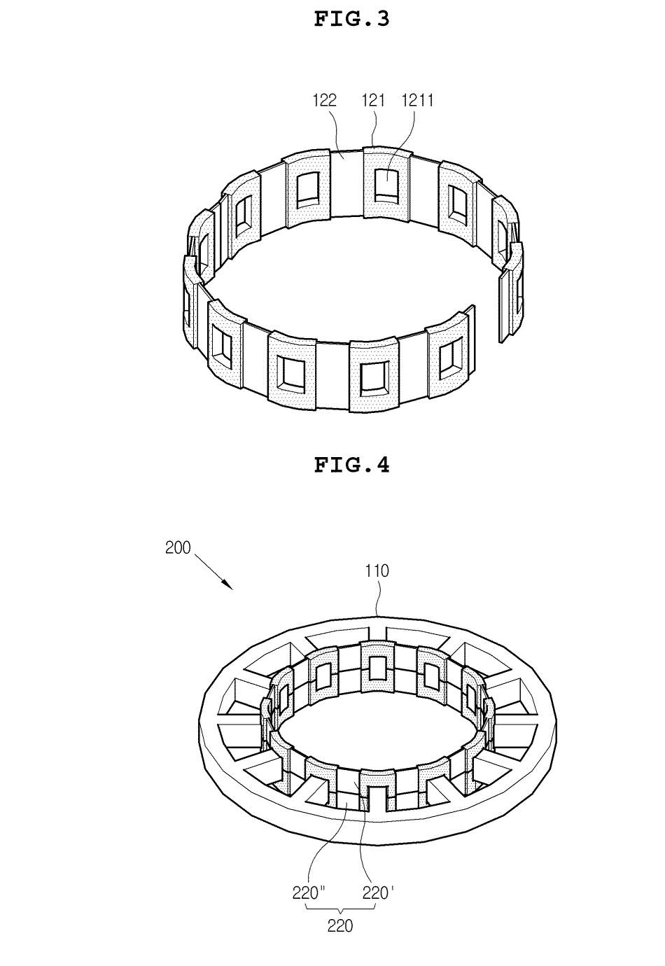

FIGS. 1 and 2 are view showing a stator assembly for a motor according to a first preferred embodiment of the present invention and FIG. 3 is an enlarged view of a tip member to be mounted on the stator assembly for a motor according to the first preferred embodiment of the present invention.

As shown in FIGS. 1 to 3, the stator assembly 100 for a motor according to the present invention is configured to include a core member 110 and a tip member 120. Particularly, in the stator assembly 100, coils (not shown) are wound around coil winding parts 112 of the core member 110.

The core member 110 includes a yoke part 111 and the coil winding parts 112, wherein the yoke part 111 has a ring shape and a plurality of coil winding parts 112 are extended inwardly along an inner peripheral surface of the yoke part 111. The coil winding part 112 include the coil (not shown) wound therearound so as to provide alternating magnetic force by applying power.

The coil winding parts 112 have a spoke shape in which they are spaced apart from the yoke part 111 at equidistance in a circumferential direction as shown in FIGS. 1 to 3, and have a length at which they do not contact the rotor (not shown) mounted with a plurality of magnets (not shown) magnetized so as to have alternating polarity in the circumferential direction.

In the stator assembly 100 for a motor according to the present invention, the tip member 120 is arranged at the end portion of the coil winding part 112 of the core member 110.

Preferably, the tip member 120 may include at least one mounting part 121 and at least one connecting part 122 that are alternately arranged.

The mounting part 121 includes a hollow part 1211 at a central portion thereof, and the end portion of the coil winding part 112 is inserted into the hollow part 1211 of the mounting part 121. The number of mounting parts 121 is the same as that of coil winding part 112.

The coil winding part 112 may have the same cross-sectional shape as that of the hollow part 1211, thereby certainly fixing the core member 110 and the tip member 120 to each other.

The mounting part 121 is made of a magnetic material. Especially, the mounting part 121 is made of a soft magnetic composite (SMC) capable of being manufactured in various 3-dimensional shapes by compression molding of soft magnetic powder coated so as to be electrically insulated.

In addition, the connecting part 122 is made of a soft and flexible material to thereby be easily bent, and preferably is made of a plastic material. Therefore, since the connecting member 122 is made of a non-magnetic material, movement of a magnetic flux between the mounting parts 121 adjacent to each other may be shielded.

For reference, the tip member 120 is formed by combining the mounting part 121 made of the soft magnetic composite and the connecting part 122 made of the plastic material. The plastic material and other materials may be coupled to each other and/or assembled by an insert injection molding method to reduce a difference in strength, thereby making it possible to be firmly assembled.

Referring to FIGS. 1 to 3, the tip member 120 according to the present invention has a long band shape, and the mounting part 121 of the long band shaped tip member 120 is inserted at each of the end portions of the coil winding part 112 to thereby be fixed thereto. Both end portions of the tip members 120 are overlapped with each other or arranged in a ring shape along a virtual circumference that will be formed of the end portions of the plurality of coil winding parts 112 by various coupling methods such as a press-fitting method, or the like. The tip member 120 is not limited to having a band shape as shown in FIGS. 2 and 3, but may be manufactured in a ring shape in which it has the same diameter as that of a virtual circle formed of the end portions of the coil winding part 112. In addition, the connecting part disposed between two mounting parts 121 arranged to be adjacent to each other so that the mounting parts 121 may be correctly positioned at the plurality of coil winding parts 112 may have the same length as the distance spaced between the end portions of the coil winding parts 112.

As widely known in those skilled in the art, the tip member 120 arranged in the ring shape form a predetermined gap between the tip member 120 and an edge of the rotor (not shown) to be space apart from the rotor including the magnet mounted thereon.

For reference, the motor includes the rotor coupled to a shaft arranged at a central portion thereof to thereby be rotatably received in the stator assembly 100 for a motor according to the present invention, wherein the rotor includes the magnet, such that high torque rotational force is generated by interaction between the magnetic flux by the current applied to the coil wound in the stator assembly 100 and the magnet mounted on the rotor.

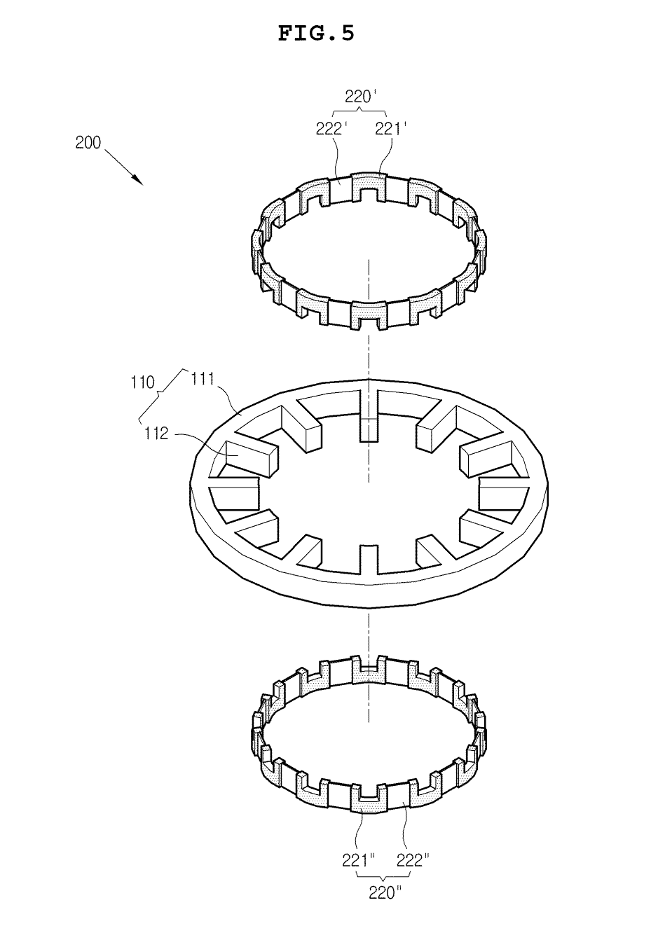

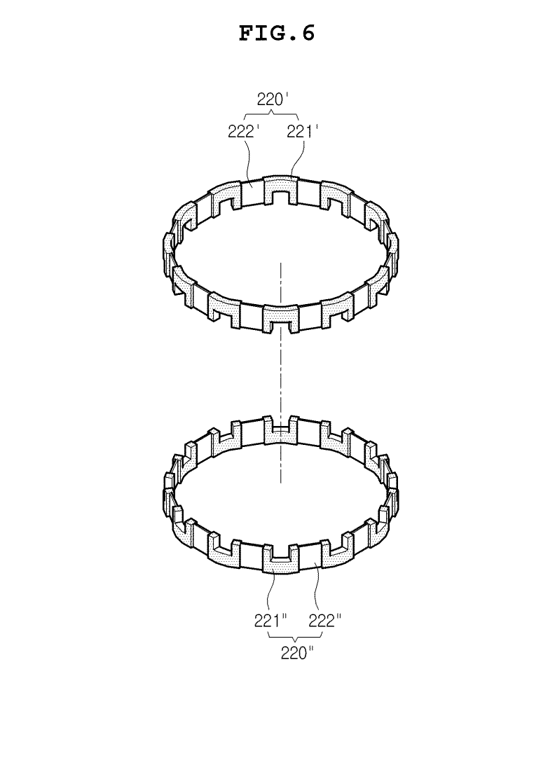

FIGS. 4 and 5 are views showing a stator assembly for a motor according to a second preferred embodiment of the present invention and FIG. 6 is a detailed view of a tip member to be mounted on the stator assembly for a motor according to the second preferred embodiment of the present invention.

The stator assembly 200 for a motor according to the second preferred embodiment of the present invention is similar to the stator assembly 100 for a motor according to the first preferred embodiment of the present invention shown in FIGS. 1 to 3 except for a shape of the tip member 120. Therefore, in order to assist in the clear understanding of the present invention, a description of the components that are similar to or the same as those in the stator assembly 100 will be omitted.

As shown in FIGS. 4 to 6, in the stator assembly 200 for a motor according to the second preferred embodiment of the present invention, two tip half parts 220′ and 220″ are arranged to face each other, thereby forming one tip member 220. That is, the tip member 220 is configured of a first tip half part 220′ arranged at an upper portion in a ring shape and a second tip half part 220″ arranged at a lower portion in the ring shape, wherein the first and second tip half parts 220′ and 220″ have the same shape and size as each other.

The first tip half part 220′ may include at least one fitting part 221′ and at least one connecting part 222′ that are alternately arranged. The fitting part 221′ has an opened lower portion in an upside down U-shape and the number of fitting parts is the same as that of coil winding part 112. In addition, the fitting part 221′ is formed to have the same cross-sectional shape as that of an upper portion of the coil winding part 112.

Similarly, the second tip half part 220″ may include at least one fitting part 221″ and at least one connecting part 222″ that are alternately arranged. Further, the fitting part 221″ has an opened upper portion in a U-shape and the number of fitting parts is the same as those of the coil winding part 112 and the fitting part 221′. In addition, the fitting part 221″ is formed to have the same cross-sectional shape as that of a lower portion of the coil winding part 112. In this structure, the fitting part 221′ of the first tip half part 220′ and the fitting part 221″ of the second tip half part 220″ are vertically arranged in parallel with each other, such that hollow parts are formed therebetween, thereby receive the end portions of the coil winding part 112 therein.

In other words, after the fitting parts 221′ of the first tip half part 220′ are seated on upper portions of the end portions of the plurality of coil winding parts 112 extended from the yoke part 111 of the core member 110 in the spoke shape, respectively, the fitting parts 221″ of the second tip half part 220″ are closely adhered to lower portions of the end portions of the plurality of the coil winding parts 112, respectively. Two ring shaped tip half parts 220′ and 220″ attached to the end portion of the coil winding part 112 may be firmly coupled to each other to form the ring shaped-tip member 220 in the core member 110. The tip member 220 of the stator assembly 200 according to the second preferred embodiment of the present invention may be coupled regardless of the above-mentioned coupling sequence. The tip half parts 220′ and 220″ have the same diameter as that of a circle formed by connecting the end portions of the coil winding parts 112 with a virtual line, and preferably, may form a predetermined gap with the edge of the rotor.

The fitting parts 221′ and 221″ may be made of magnetic material, especially soft magnetic composites (SMC) capable of being manufactured in various 3-dimensional shapes, but the connecting parts 222′ and 222″ may be made of plastic materials capable of being easily bent.

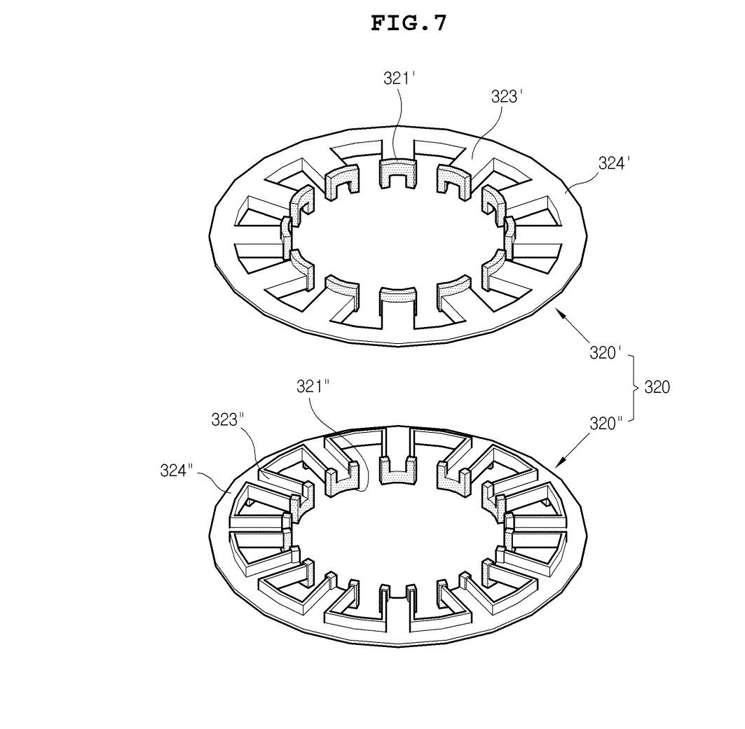

FIG. 7 is an enlarged view of another tip member to be mounted on a stator assembly for a motor according to a third preferred embodiment of the present invention, and a core member is omitted in order to clearly show a structure of the tip member.

The stator assembly for a motor according to the third preferred embodiment of the present invention is configured of the core member 110 (not shown) shown in FIGS. 1 and 2 and a tip member 320.

Particularly, the tip member 320 is configured of a first tip half part 320′ arranged at the upper portion of the core member 110 (shown in FIGS. 1 and 2) in a spoke shape and a second tip half part 320″ arranged at the lower portion of the core member 110 in the spoke shape.

The first tip half part 320′ may include at least one fitting part 321′ having a generally upside down U-shaped cross-section, at least one coil winding part upper cover 323′ having a generally upside down U-shaped cross-section, and a yoke part upper cover 324′ having a ring shape and be an integrated single component.

The numbers of fitting part 321′ and coil winding part upper cover 323′ are the same as that of coil winding part of the core member, and the fitting part 321′ and the coil winding part upper cover 323′ have the same spoke arrangement as that of the coil winding part.

Particularly, the first tip half part 320′ has a shape in which it may be arranged at the upper portion of the core member as described above. More specifically, the fitting part 321′ and/or the coil winding part upper cover 323′ are formed to have the same shape as that of the upper portion of the coil winding part so as to enclose the upper portion and upper side surfaces of the coiling winding part 112 (shown in FIG. 2), and the yoke part upper cover 324′ is formed to have the same shape as that of an upper portion of the yoke part so as to enclose the upper surface of the yoke part, such that the first tip half part 320′ may be certainly seated on the upper portion of the core member.

Similarly, the second tip half part 320″ may include at least one fitting part 321″ having a generally U-shaped cross-section, at least one coil winding part lower cover 323″ having a generally U-shaped cross-section, and a yoke part lower cover 324″ having a ring shape and be formed of an integrated single component. The numbers of fitting part 321″ and coil winding part lower cover 323″ are the same as that of coil winding part of the core member, and the fitting part 321″ and the coil winding part lower cover 323″ have the same spoke arrangement as that of the coil winding part.

Particularly, the second tip half part 320″ has a shape in which it may be arranged at the lower portion of the core member as described above. More specifically, the fitting part 321″ and/or the coil winding part lower cover 323″ are formed to have the same shape as that of the lower portion of the coil winding part so as to enclose the lower portion and lower side surfaces of the coiling winding part 112 (shown in FIG. 2), and the yoke part lower cover 324″ is formed to have the same shape as that of an lower portion of the yoke part so as to enclose the lower surface of the yoke part, such that the second tip half part 320″ may be certainly closely adhered to the lower portion of the core member.

The coil winding part covers 323′ and 323″ and the yoke part covers 324′ and 324″ are made of a non-magnetic material capable of being smoothly and easily bent, for example, a plastic material, thereby shielding movement of a magnetic flux to the core member 110.

Unlike this, the fitting parts 321′ and 321″ may be preferably made of a magnetic material or a soft magnetic composite ((SMC) capable of being manufactured in various 3-dimensional shapes.

In the stator assembly for a motor according to the preferred embodiments of the present invention, although the case in which the tip member used in the internal stator including the coil winding part protruding inwardly from an inner peripheral surface of the yoke part is shown in the accompanying drawing, the present invention is not limited thereto, but the tip member may be used in an external stator.

According to the preferred embodiments of the present invention, the stator assembly for a motor capable of mounting the tip member integrally formed with the soft magnetic composite on the end portion of each of the coil winding parts may be provided.

In the present invention, the tip member is formed integrally with another non-magnetic material together with the soft magnetic composite, thereby making it possible to improve mechanical rigidity of the tip member.

In addition, according to the present invention, the coil winding part may be insertedly fixed using the hollow part formed in the tip member. Therefore, the core member having a 3-dimensional shape may be used instead of a core member formed of laminated steel plates.

Particularly, according to the present invention, the magnetic material such as the soft magnetic composite is disposed at the surfaces facing the magnet of the rotor, thereby making it possible to improve efficiency of the motor while reducing loss of the magnetic flux.

According to the present invention, the tip member having the ring shape or the band shape may be simply disposed at the end portion of the coil winding part, thereby making it possible to maximize productivity and reduce man-hours.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A stator assembly for a motor comprising:
a core member provided with a ring shaped yoke part and a plurality of coil winding parts spaced apart from each other at equidistance in a circumferential direction to be extended from the yoke part; and
a band shaped tip member alternately provided with at least one mounting part having a hollow part and at least one connecting part disposed between the mounting parts.

2. The stator assembly for a motor as set forth in claim 1, wherein the mounting part is made of a magnetic material.

3. The stator assembly for a motor as set forth in claim 1, wherein the hollow part of the mounting part has the same cross-sectional shape as that of an end portion of the coil winding part.

4. The stator assembly for a motor as set forth in claim 1, wherein the band shaped tip member has a length equal to or longer than a circumference of a virtual circle formed of end portions of the plurality of coil winding parts.

5. The stator assembly for a motor as set forth in claim 1, wherein the tip member has a ring shape.

6. The stator assembly for a motor as set forth in claim 1, wherein the connecting part is made of a non-magnetic material.

7. The stator assembly for a motor as set forth in claim 1, wherein the number of mounting parts is the same as that of coil winding part.

8. The stator assembly for a motor as set forth in claim 1, wherein the connecting part is extended at the same length as a spaced distance between end portions of the plurality of coil winding parts.

9. A stator assembly for a motor comprising:
a core member provided with a ring shaped yoke part and a plurality of coil winding parts spaced apart from each other at equidistance in a circumferential direction to be extended from the yoke part; and
a ring shaped tip member configured of a first tip half part including at least one fitting part and at least one connecting part that are alternately arranged in a ring shape and a second tip half part including at least one fitting part and at least one connecting part that are alternately arranged in a ring shape,
wherein the fitting parts of the first and second tip half parts are arranged to face each other to form hollow parts, and end portions of the coil winding parts are seated in the hollow parts.

10. The stator assembly for a motor as set forth in claim 9, wherein the fitting part is made of a magnetic material.

11. The stator assembly for a motor as set forth in claim 9, wherein the fitting part of the first tip half part has the same cross-sectional shape as that of an upper portion of the end portion of the coil winding part, and the fitting part of the second tip half part has the same cross-sectional shape as that of a lower portion of the end portion thereof.

12. The stator assembly for a motor as set forth in claim 9, wherein the ring shaped tip member has the same length as a circumference of a virtual circle formed of end portions of the plurality of coil winding parts.

13. The stator assembly for a motor as set forth in claim 9, wherein the connecting part is made of a non-magnetic material.

14. The stator assembly for a motor as set forth in claim 9, wherein the connecting part is extended at the same length as a spaced distance between the end portions of the plurality of coil winding parts.

15. A stator assembly for a motor comprising:
a core member provided with a ring shaped yoke part and a plurality of coil winding parts spaced apart from each other at equidistance in a circumferential direction to be extended from the yoke part; and
a tip member configured of a first tip half part including at least one fitting part, at least one coil winding part upper cover, and a ring shaped yoke part upper cover and a second tip half part including at least one fitting part, at least one coil winding part lower cover, and a ring shaped yoke part lower cover,
wherein the fitting parts of the first and second tip half parts are arranged to face each other to form hollow parts, and the coil winding parts are seated in the hollow parts.

16. The stator assembly for a motor as set forth in claim 15, wherein one end portions of the coil winding part upper and lower covers are coupled to the ring shaped yoke part upper and lower covers, and the other end portions of the of the coil winding part upper and lower covers are coupled to the fitting parts of the first and second tip half parts.

17. The stator assembly for a motor as set forth in claim 15, wherein the numbers of fitting parts and coil winding parts cover are the same as that of coil winding parts.

18. The stator assembly for a motor as set forth in claim 15, wherein the coil winding part upper cover has the same shape as that of an upper portion of the coil winding part, and the coil winding part lower cover has the same shape as that of a lower portion thereof.

19. The stator assembly for a motor as set forth in claim 15, wherein the yoke part upper cover has the same shape as that of an upper surface of the yoke part, and the yoke part lower cover has the same shape as that of a lower surface thereof.

20. The stator assembly for a motor as set forth in claim 15, wherein the coil winding part upper and lower covers are arranged in the same shape as a shape in which the coil winding parts are arranged.

21. The stator assembly for a motor as set forth in claim 15, wherein the fitting part is made of a magnetic material.

22. The stator assembly for a motor as set forth in claim 15, wherein the fitting part of the first tip half part has the same cross-sectional shape as that of an upper portion of the end portion of the coil winding part, and the fitting part of the second tip half part has the same cross-sectional shape as that of a lower portion of the end portion thereof.
